(19) United States
(12) Patent Application Publication
(10) Pub. No.: US 2026/0251040 A1
(43) Pub. Date: Aug. 27, 2026

(54) HYDRAULIC FRACTURING PROCESS OPTIMIZATION

(71) Applicant: Abu Dhabi National Oil Company, Abu Dhabi (AE)

(72) Inventors: Chakib Kada KLOUCHA, Abu Dhabi (AE); Travis St. George RAMSAY, Abu Dhabi (AE); Rahul Mark FONSECA, Abu Dhabi (AE); Imad Al HAMLAWI, Abu Dhabi (AE)

(73) Assignee: Abu Dhabi National Oil Company, Abu Dhabi (AE)

(21) Appl. No.: 18/877,330

(22) PCT Filed: Jun. 30, 2022
(86) PCT No.: PCT/IB2022/056103

§ 371 Date: Dec. 20, 2024

(51) Int. Cl. E21B 43/26

(52) U.S. Cl. CPC E21B 43/26; E21B 2200/20

(57) ABSTRACT

A method for optimizing a hydro mechanical fracturing process, the method comprising the following steps: a. Loading of static and dynamic data; b. Loading of a pressure-fracture aperture relationship curve; and c. Generating a hydraulic fracture process model by repeating the following steps c1 to c3 by using the static and dynamic data: c1. Solving a Discrete Fracture Network (DFN) flow model; c2. Updating fractures apertures of the Discrete Fracture Network (DFN) using the pressure-fracture aperture relationship curve; and c3. History matching reservoir data by updating the pressure-fracture aperture relationship curve; d. Simulating a hydromechanical fracturing for a specific reservoir based on the hydraulic fracture process model to generate optimized process parameters; and e. Performing hydro mechanical fracturing using the optimized process parameters.

### FIELD OF THE INVENTION

The present invention relates to the field of the exploitation of a subterranean medium, such as an oil or gas reservoir particularly by hydraulic fracturing. The invention is related to a modeling of the hydraulic fracturing process particularly in tight reservoirs for the optimization of a hydraulic fracturing process in order to exploit subsurface resources.

### PRIOR ART

“Tight reservoir” is a term commonly used to refer to low permeability reservoirs and such reservoirs are generally naturally fractured. A well in a tight reservoir generally produces lower volumes of hydrocarbons as compared to wells in conventional reservoirs. To reach a commercial production rate of hydrocarbons, the reservoir's permeability needs to be increased. For this purpose, different stimulation process may be used such as hydraulic fracturing stimulation.

The production of hydrocarbons trapped in unconventional (i.e. where reservoir permeability is very low) plays depends on the ability to drain efficiently and safely the wellbore area within tight formations. To date, hydraulic fracturing is the main operational technique to turn a tight reservoir into an economically exploitable resource. The injection of a high-pressure fluid induces new channels in the rock and enhances the ultimate recovery of hydrocarbons.

However, the result of this technique remains difficult to assess and to model due to the complexity of the involved mechanisms and the heterogeneities governing flows in such environment. Considering the amount of data available, like microseismic event records, it becomes clear that pre-existing geological properties such as natural fractures and bed boundaries, which can be classified as weak points in the geological rock system, are reactivated during such hydraulic fracturing jobs.

“Hydraulic fracturing”, also called “hydraulic fracking” or “hydrofracking” is a process which aims at unlocking for production the hydrocarbons trapped in unconventional/tight reservoir formations. It stimulates the flow of hydrocarbons by injecting a fluid, usually water mixed with other components, in order to create new fractures or/and to reactivate existing ones in the formation.

Previously, a study of a subterranean medium, notably a hydrocarbon field and tight/shale reservoir has been done prior to production to find the optimal location for hydraulic fracturing. Such a study required the construction of models, known as “geological models” in the broad sense. These geological models make it possible to determine technical parameters related to the research, study or exploitation of a reservoir of hydrocarbons for example. Therefore, geological models to some extent represent the structure of the reservoir as well as its properties including the dynamic response of the model. Generally, such a geological model can be a numerical model represented on a computer.

Such geological models can also be used to simulate the hydraulic fracturing process. To this end, stimulation process modeling includes elasto-plastic geomechanical laws, where the existing fracture network under the field stress tenor is reactivated driven by the pressure build up. The hydraulic fracturing process aims at making this stimulation irreversible by mixing the injected water with other components: chemicals and/or proppant and reaching the Mohr-Coulomb failure criterion to induce a plastic irreversible response.

The created geological model can be history-matched (i.e. assimilated with data) using dynamic data, such as well pressure and/or micro-seismicity signatures among other data types which are present.

This history matching is carried out by seeking to minimize the error between the observed pressure curves and the simulated pressures curves from the geological numerical model. However, the uncertainties affecting the fracture properties and the local field stress tensor combined with the complexity of the geo-mechanical model reduces the chances of matching the observed data in a satisfactory way, and therefore of obtaining a reliable model.

Such geo-mechanical models were described in the papers Delorme, M., Daniel, J.-M., Kada-Kloucha, C., Khvoenkova, N., Schueller, S., & Souque, C. (2013, Aug. 12): “An Efficient Model to Simulate Reservoir Stimulation and Induced Microseismic Events on 3D Discrete Fracture Network for Unconventional Reservoirs”, Society of Petroleum Engineers. doi:10.1190/URTEC2013-146 and Delorme, M., Mota, R. O., Khvoenkova, N., Fourno, A., & Noetinger, B. (2013): “A methodology to characterize fractured reservoirs constrained by statistical geological analysis and production: a real field case study”, Geological Society, London, Special Publications, 374, SP374-14″.

The paper Quinghua Lei, John-Paul Latham, Chin-Fu Tsang (Jan. 2, 2017): “The use of discrete fracture networks for modelling coupled geomechanical and hydrological behaviour of fractured rocks”, Elsevier Ldt. discloses a method of calibrating the measured Fracture apertures with a coupled dynamic/geomechanical model for classical and unconventional reservoirs.

The document US 2017 0370197 A1 discloses hydraulic fracturing in kerogen-rich unconventional formations and discloses different ways to characterize Discrete fracture network (DFN) for unconventional reservoirs based on geo-mechanical models.

The document CN 107545113 A discloses a simulating method of forming process of unconventional oil and gas reservoir hydraulic fracturing complex fracture net.

A good modelling and simulation of the stimulation process helps to an improvement of the use of the reservoir and to an optimization of the field exploitation. Therefore, a need arises to efficiently model the process of hydrocarbon recovery via fracturing.

### SUMMARY OF THE INVENTION

The above-mentioned problem and other problems are solved by a method according claim 1.

Particularly, the above-mentioned problem is solved by a method for optimizing a hydromechanical fracturing process, the method comprising the following steps:
a. Loading of static and dynamic data, preferably in a geological numerical model;
b. Loading of a pressure-fracture aperture relationship curve; and
c. Generating a hydraulic fracture process model by repeating the following steps c1 to c3 by using the static and dynamic data:
   c1. Solving a Discrete Fracture Network (DFN) flow model;
   c2. Updating the fractures apertures of the Discrete Fracture Network (DFN) using the pressure-fracture aperture relationship curve;
   c3. History matching reservoir data by updating the pressure-fracture aperture relationship curve;
d. Simulating a hydromechanical fracturing for a specific reservoir based on the hydraulic fracture process model to generate optimized process parameters; and
e. Performing hydromechanical fracturing using the optimized process parameters.

The present application relates to hydraulic fracturing, i.e. a process where fractures are induced to an underground formation by pumping a fluid into a well-bore at a particular pressure. To characterize the subterranean medium, geological models are commonly used, while the present invention aims at using pressure/fracture-aperture curves.

The present invention simplifies the hydraulic fracture process modelling in case of unconventional reservoirs used for the hydromechanical fracturing process. This modelling framework provides optimized process parameters that are then used during the actual hydromechanical fracturing of a hydrocarbon reservoir. In the present invention the hydraulic fracturing process is simulated by generating a hydraulic fracture process model that uses pressure/fracture-aperture curves.

The method uses the loaded static and dynamic data in generating the hydraulic fracture process model.

The DFN flow model is a simulation approach to model the flow in the DFN (Discrete Fracture Network). Various approaches are available to simulate flow and transport in the fractured reservoir. These approaches can be divided into two categories: 1—the DFN flow model and 2—the Equivalent Continuum Model. The DFN flow model explicitly represents individual fractures, while the ECM uses fracture properties to determine equivalent continuum parameters.

Thereby, the static data can comprise all data used to characterize the reservoir. The static data preferably comprises the rock properties, rock-type distribution, facies, initial fluids distribution, etc. The rock properties comprise porosity, permeability and compressibility. From such data the static model, like a fracture model and a rock properties model is built. The static data can be obtained from seismic data, well cores, outcrop data and other similar methods.

The dynamic data preferably comprises the production data, fluid distributions and geo-mechanical data. The production data can comprise production rates (volumes/time), well pressure curves, fluids saturations or the like. The geo-mechanical data can comprise stress and strain data. Such dynamic data can be obtained from well tests, production history, 4D seismic data, and other similar methods. Thus, such dynamic data can comprise historical data and actual data from the actual field.

The steps c1, c2 and c3 are repeated several times. The minimum and or maximum number iterations as well as the tolerance error can be defined by the user. The hydraulic fracture process model is converging if results are under tolerance error. The maximum number of iterations may be preferably set to be in the hundreds.

The step of history matching reservoir data by updating the pressure-fracture aperture relationship curve preferably comprises computing reservoir data from the DFN flow model and comparing the same with physically measured reservoir data.

By using optimized parameters for the hydraulic fracturing process subsurface resources can much better be exploited. The information that is collected from this optimizing method is used to design and implement the most favorably economic intervals of the subsurface for targeted production of hydrocarbon resources, what includes conventional and unconventional reservoirs, and can be also used for a stimulation for enhanced geothermal systems.

Preferably, the step c. of generating a hydraulic fracture process model further comprises the step of c4. matching existing leak off tests by updating the pressure-fracture aperture relationship curve.

Preferably, the step of loading of a pressure-fracture aperture relationship curve includes determining the pressure-fracture aperture relationship curve from laboratory experiments or outcrop studies; and/or from pressure-fracture aperture relationship curves of similar reservoirs; and/or from an artificial intelligence model; and/or from analysis of a geological outcrop study.

A pressure/aperture curve is associated to each fracture family. These curves can be obtained numerically by using a geo-mechanical model of a chosen well with similar properties or via tests in laboratories. Optionally, the use of an artificial intelligence (AI) algorithm will simplify the hydraulic fracturing process modelling and reduce the uncertainty and request less data.

Preferably, the reservoir data comprises pressure data and/or microseismisity data.

Preferably, the optimized process parameters comprise injection fluid pressure and/or injection fluid rate and/or injection duration.

Preferably, the DFN flow model is a static model describing the fracture network.

Preferably, the DFN flow model is a stochastically generated model.

Preferably, the DFN flow model is generated based on fracture medium parameters.

Preferably, the fracture medium parameters include one or more of:
number of fractures per volume (i.e. the density of fracture),
the mean length,
the mean height,
the mean aperture,
the mean conductivity,
the mean orientation.

Preferably, the DFN flow model comprises a Discrete Fracture Network (DFN) that represents the subsurface using the static data. The DFN is a static model describing the fracture network. The DFN is usually stochastically generated based on the fracture medium parameters which are the density of the fracture (number of fractures/volume), the mean length, the mean height, the mean aperture, the mean conductivity and the mean orientation.

Preferably, the step (c1.) of solving the DFN flow model generates a map of the pressure and saturation profile of a well.

Preferably, in the step (c3.) of history matching the reservoir data is computed from the DFN flow model and compared with physically measured reservoir data.

Preferably, the steps (b.) of loading of a pressure-fracture aperture relationship curve and (c.) of generating a hydraulic fracture process model comprises the steps of:
Uploading the initial pressure-fracture aperture curve;
Solving the DFN flow model and calculate the pressure;
Compare the calculated pressure with real pressure data;
Updating the fracture aperture based on the pressure-fracture aperture curve and calculated pressure for each time step.

Thus, the pressure-fracture aperture curve is updated through calibration of the parameters governing the pressure-fracture aperture curve equation.

Preferably, the step (e.) of performing hydromechanical fracturing using the optimized process parameters comprises stimulating or enhancing production of oil or gas through preferentially induced fracture conduits within subsurface rock.

### DESCRIPTION OF PREFERRED EMBODIMENTS

In the following preferred embodiments of the invention are described with reference to the figures, which shows:

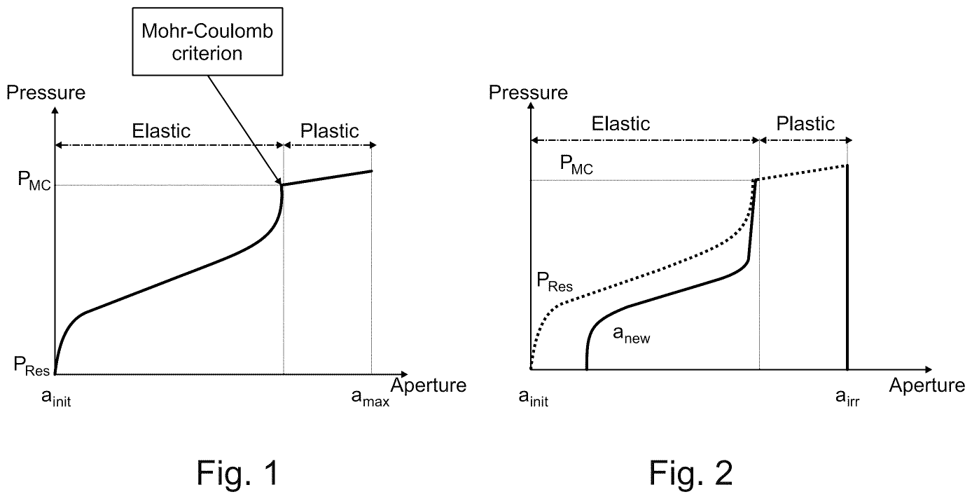

FIG. 1: an exemplary pressure-fracture aperture relationship curve for a build-up pressure phase;

FIG. 2: an exemplary pressure-fracture aperture relationship curve for a drawdown pressure phases;

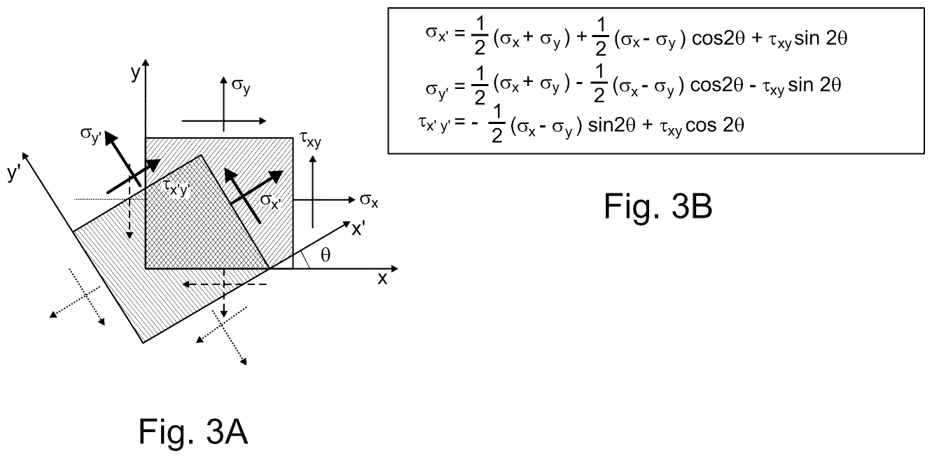

FIG. 3A: a sign convention for a multi fracture set;

FIG. 3B: transformation equations for a multi fracture set;

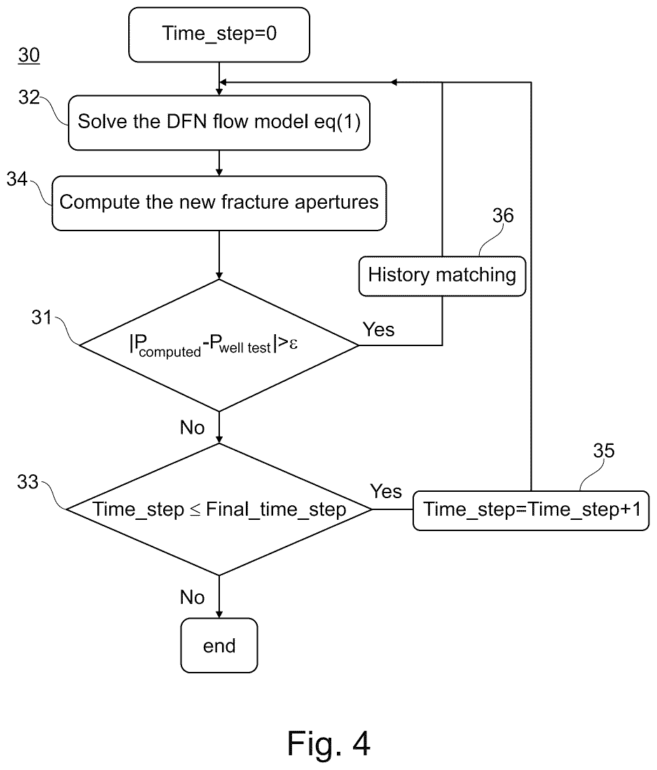

FIG. 4 a flowchart of an exemplary embodiment of an algorithm for generating a hydraulic fracture process model;

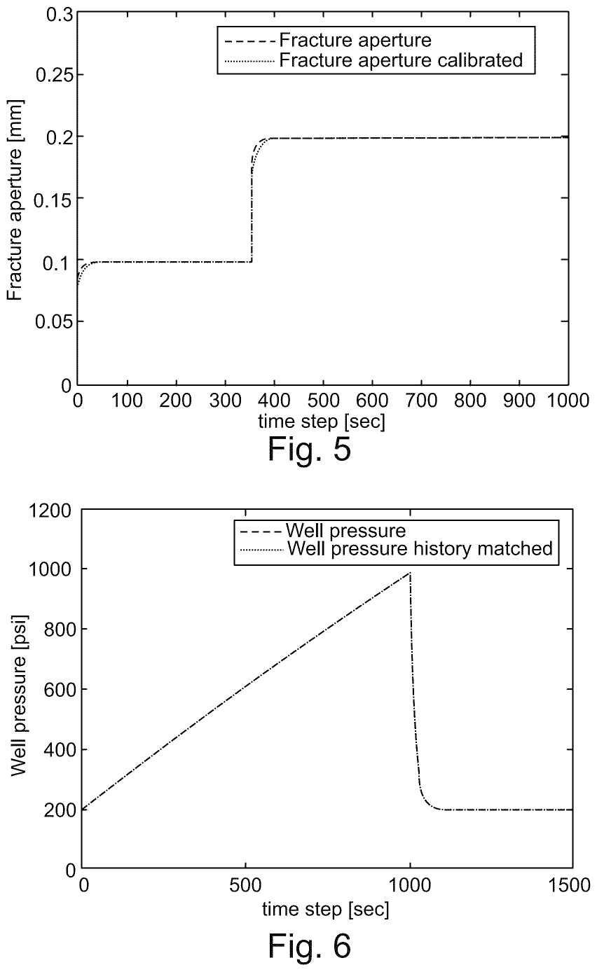

FIG. 5 an exemplary diagram of the fracture aperture versus time steps;

FIG. 6 an exemplary diagram of the well pressure versus time steps;

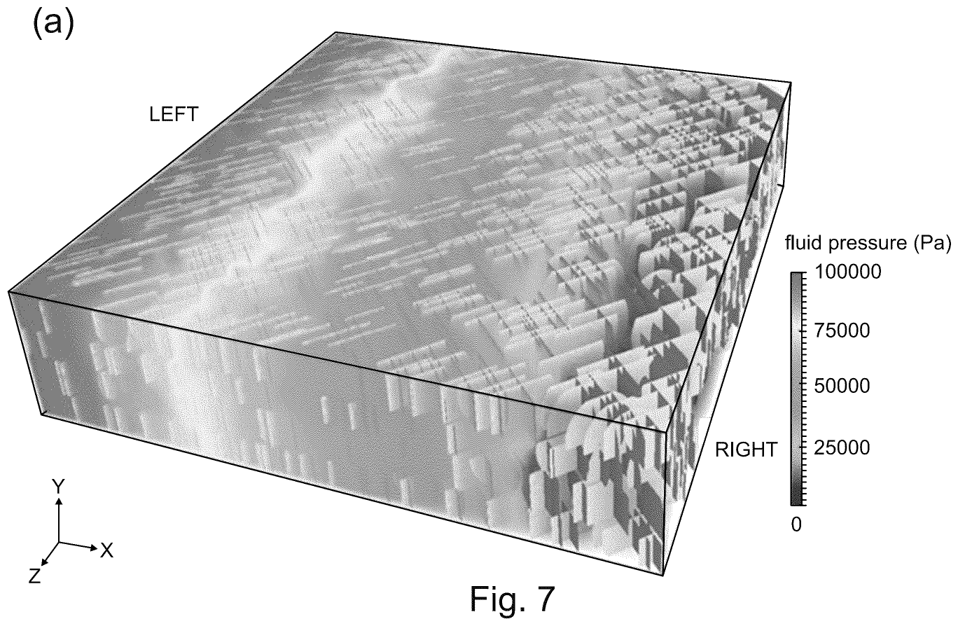

FIG. 7 an example of a pressure map generated by solving a DFN flow model;

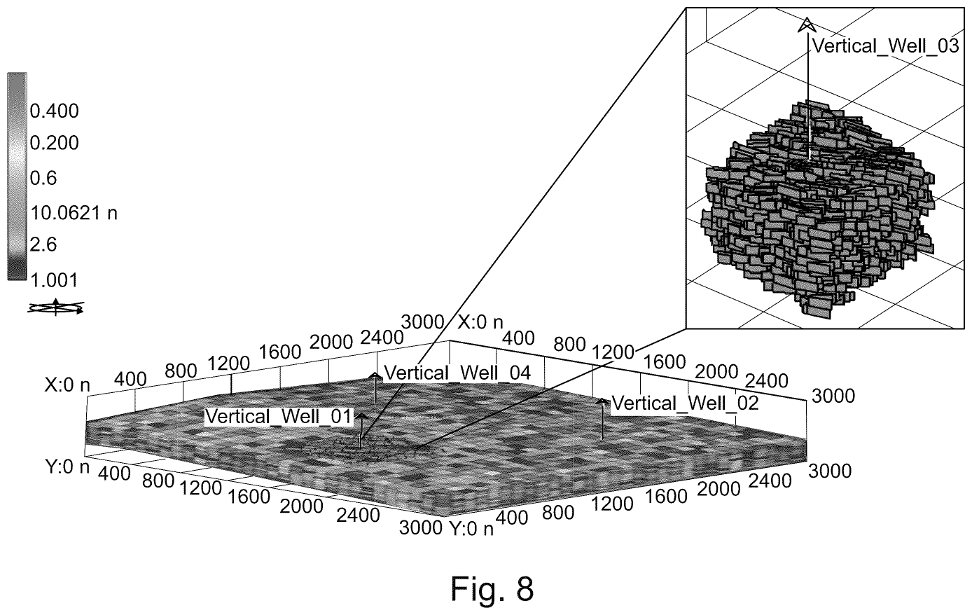

FIG. 8 an example of a stochastically generated DFN;

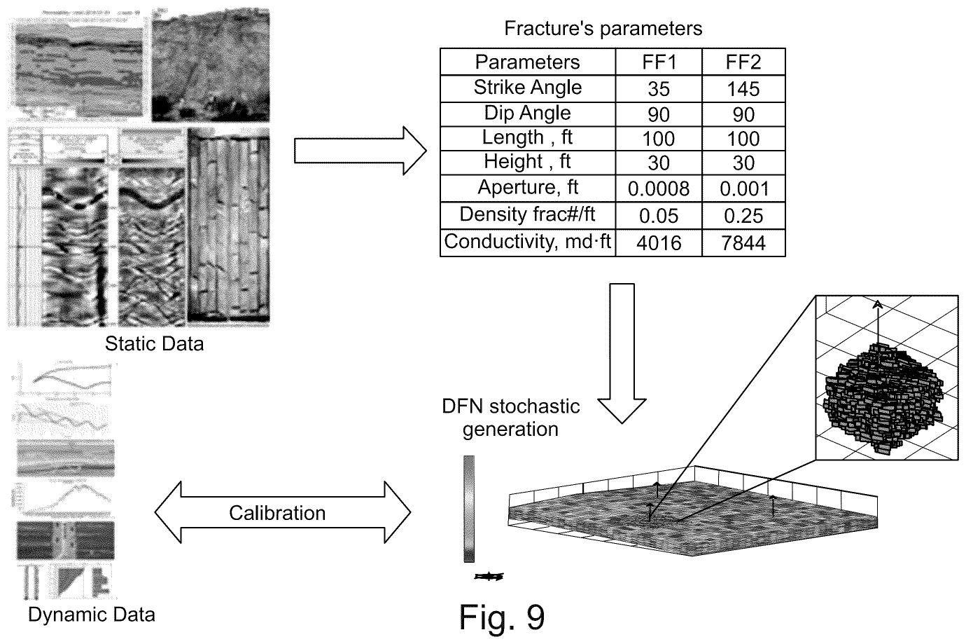

FIG. 9 a schematic diagram of generating a hydraulic fracture process model by using a DFN; and

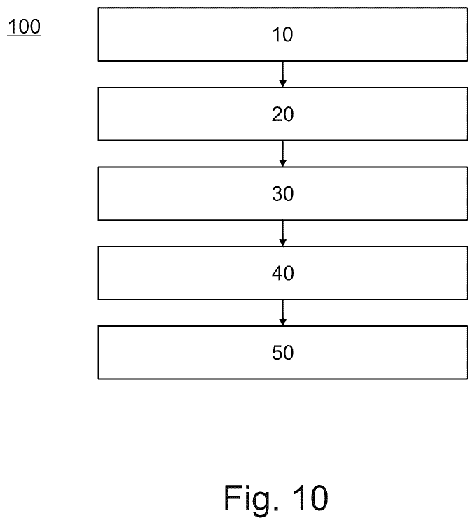

FIG. 10 a schematic illustration of an embodiment of a method for optimizing a hydromechanical fracturing process.

The invention relates to a method 100 for exploiting a subterranean medium, notably a hydrocarbon reservoir. The term “hydrocarbons” should be understood within the meaning of the present invention as, e.g., oil-bearing products such as oil or crude oil, petrol or extra-heavy oil, asphaltenic sands, bituminous schists and gases present in a subterranean formation. The method 100 according to the invention is also adapted to the exploitation of gas storage reservoirs, containing gases such as CO2. The subterranean medium is fractured (or faulted) and is passed through by at least one well for its exploitation.

A fault (or a fracture) is a surface generated by a shear break separating the rock by creating a throw between two adjacent blocks. Three types of fault can be discerned in a reservoir. Thus, the term “family of fractures”, i.e. sets of fractures with a same geological origin, is likewise used for the types of fault:

Seismic faults are large attributes visible on seismic probes. These are objects of large size (of several hundreds of meters to several kilometers). Seismic faults can be modelled explicitly, i.e. non-stochastically.

Sub-seismic faults are attributes, the size of which is not large enough for them to be visible on seismic images. This involves fracturing at a very variable scale (in the order of the meters); this type of fracture can be modelled by stochastic methods.

Diffuse faults correspond to fracturing on a small scale (in the order of the meter) and can be modelled by stochastic methods i.e. by a set of distribution law parameters.

The so-called fractured geological model (or reservoir model) is a representation of the subterranean medium, in which the geometry of the faults is generally represented by Boolean objects. In two dimensions, the faults are represented by outlines and in three dimensions by surfaces. Properties such as porosity, permeability, effective aperture, etc are associated with each object.

Diffuse fractures that are added by so-called “probabilistic” construction methods due to the limitations of the information available (restricted number of wells etc.) Due to this, the geological models (or reservoir models) built from these probabilistic methods are called “stochastic models”. The diffuse fractures are grouped into different fracture families.

A fracture family is a set of fracture represented by the same fracture geometrical and dynamic properties (density, length, height, aperture, orientation and permeability). To simplify the model, the present invention relates to a method for representing the hydraulic fracturing process through pressure/fracture-aperture curves as shown in FIGS. 1 and 2.

In geo-mechanics the fractures subject to pressure increase shows two kind of behaviour (elastic and plastic) and the fracture aperture will increase as described in FIG. 1. After stopping to inject water the pressure will drop and the fracture aperture will decline but it will not go back to the initial aperture (it will follow a different path) as described and shown in FIG. 2.

A pressure/aperture curves (similar to KrPc/Hysteresis curves) is associated to each fracture family. These curves can be obtained numerically by using a complete geo-mechanical model around a chosen well or via lab-tests. As the fractures within the same family (same orientation) in the same rock type responds similarly to the pressure change, these curves can be generalized to the field using sign convention of FIG. 3A and transformation equations of FIG. 3B and can be more easily history-matched.

There are different ways to model the flow in a fractured reservoir. One of them is the DFN (discrete fracture network) model. The idea is to simulate the flow in the fractures and the rock simultaneously with an exchange term between the two mediums in the model.

A method 100 for optimizing a hydromechanical fracturing process according to one embodiment is shown in FIGS. 4 and 10. It comprises the following steps:
a. Loading 10 of static and dynamic data;
b. Loading 20 of a pressure-fracture aperture relationship curve; and
c. Generating 30 a hydraulic fracture process model. By repeating the following steps for each time step and using the static and dynamic data:
   c1. Solving 32 a Discrete Fracture Network (DFN) flow model;
   c2. Updating 34 fractures apertures of the Discrete Fracture Network (DFN) using the pressure-fracture aperture relationship curve; and
   c3. History matching 36 reservoir data by updating the pressure-fracture aperture relationship curve.
d. Simulating 40 a hydromechanical fracturing for a specific reservoir based on the hydraulic fracture process model to generate optimized process parameters; and
e. Performing 50 hydromechanical fracturing using the optimized process parameters.

First a Discrete Fracture Network (DFN) is generated to represent the subsurface using the static data. This network is then coupled to a flow simulator which solves the multiphase flow problem in order to predict the flow of subsurface fluids through the fracture network present.

The DFN flow model is solved using well-know state of the art equations such as Darcy's law, Forcheimer's equation etc..

FIG. 4 shows details of the generation step 30 of the hydraulic fracture process model. First in step c1/32 a Discrete Fracture Network (DFN) flow model is solved. Then, in step c2/34 fractures apertures of the Discrete Fracture Network (DFN) using the pressure-fracture aperture relationship curve are updated by computing new fracture apertures. Then, in step 31 it is determined if the pressure computed minus the pressure of the well tested is larger than a threshold ε (|P_{computed}−P_{well test}|>ε) and if so the method 30 continues with step c3/36 history matching reservoir data by updating the pressure-fracture aperture relationship curve. If the history matching c3/36 is done and the method continues with step c1/32.

If in step 31 the pressure computed minus the pressure of the well tested is smaller or equal than threshold ε, the method continues with a determination if the necessary iterations are already performed (Time_step≤Final_time_step) or not. If the necessary iterations are not performed the method 30 continues with step 35 which increments the time step by one. The method 30 then continues with solving step c1/32. If, however, the necessary iteration are performed the method 30 ends and the method 100 continues with the simulation step d/40.

The output of solving the DFN flow model is a map of the pressure and saturation profile at every time step. An exemplary pressure map is shown in FIG. 7.

The sequence of generating a hydraulic fracture process model of step c. provides an evolved pressure-fracture aperture curve is obtained.

An example of a stochastically generated DFN is shown in FIG. 8.

FIG. 9 shows a schematic diagram of generating a hydraulic fracture process model by using a DFN.

The history-matching algorithm has been tested and validated on a synthetic case as follows:
Step 1:
   a) Running a DFN flow model with one injecting well
   b) Injecting water during 25 hours at a rate of 10 m³/min
   c) The fracture aperture is opening/closing following the dashed curve in FIG. 5 (the dashed curve is an input)
   d) Recording the pressure at the well head (dashed curve FIG. 6)
Step 2:
   a) Running the history matching algorithm on the same case
   b) Matching the pressure curve in FIG. 6 by calibrating the fracture-aperture/pressure curve in FIG. 5
   c) The pointed fracture-aperture/pressure curve in FIG. 5 is an output after calibration

FIG. 6 shows, that the history-matching algorithm is able to predict the fracture-aperture/pressure curve with high accuracy. The dashed well pressure curve perfectly overlays the pointed history matched well pressure curve.

Thus, by simulating a hydromechanical fracturing for a specific reservoir based on the hydraulic fracture process model optimized process parameters can be generated. Based on the present invention such optimized process parameters, like injection fluid pressure, injection fluid rate, injection duration for the hydromechanical fracturing can be determined and used for performing hydromechanical fracturing. This optimizes the exploitation of the field.

1. A method for optimizing a hydromechanical fracturing process, the method comprising the following steps:
a. Loading of static and dynamic data;
b. Loading of a pressure-fracture aperture relationship curve; and
c. Generating a hydraulic fracture process model by repeating the following steps c1 to c3 by using the static and dynamic data:
c1. Solving Discrete Fracture Network (DFN) flow model;
c2. Updating fractures apertures of the Discrete Fracture Network (DFN) using the pressure-fracture aperture relationship curve; and
c3. History matching reservoir data by updating the pressure-fracture aperture relationship curve;
d. Simulating a hydromechanical fracturing for a specific reservoir based on the hydraulic fracture process model to generate optimized process parameters; and
e. Performing hydromechanical fracturing using the optimized process parameters.

2. The method for optimizing a hydromechanical fracturing process according to claim 1, wherein the step (c.) of generating a hydraulic fracture process model further comprises the step of
c4. Matching existing leak off tests by updating the pressure-fracture aperture relationship curve.

3. The method for optimizing a hydromechanical fracturing process according to claim 1, wherein the step (b.) of loading of a pressure-fracture aperture relationship curve includes determining the pressure-fracture aperture relationship curve:
a. from laboratory experiments; and/or
b. from pressure-fracture aperture relationship curves of similar reservoirs; and/or
c. from an artificial intelligence model; and/or
d. analysis of a geological outcrop study.

4. The method for optimizing a hydromechanical fracturing process according to claim 1, wherein the reservoir data comprises pressure data.

5. The method for optimizing a hydromechanical fracturing process according to claim 1, wherein the reservoir data comprises microseismisity data.

6. The method for optimizing a hydromechanical fracturing process according to claim 1, wherein the optimized process parameters comprise injection fluid pressure and/or injection fluid rate and/or injection duration.

7. The method for optimizing a hydromechanical fracturing process according to claim 1, wherein the DFN flow model is a static model describing the fracture network.

8. The method for optimizing a hydromechanical fracturing process according to claim 7, wherein the DFN flow model is a stochastically generated model.

9. The method for optimizing a hydromechanical fracturing process according to claim 8, wherein the DFN flow model is generated based on fracture medium parameters.

10. The method for optimizing a hydromechanical fracturing process according to claim 9, wherein the fracture medium parameters include one or more of:
number of fractures per volume (density of fracture),
the mean length,
the mean height,
the mean aperture,
the mean conductivity,
the mean orientation.

11. The method for optimizing a hydromechanical fracturing process according to claim 1, wherein the DFN flow model comprises a Discrete Fracture Network (DFN) that represents the subsurface using the static data.

12. The method for optimizing a hydromechanical fracturing process according to claim 1, wherein the step (c1.) of solving the DFN flow model generates a map of the pressure and saturation profile of a well.

13. The method for optimizing a hydromechanical fracturing process according to claim 1, wherein in the step (c3.) of history matching the reservoir data is computed from the DFN flow model and compared with physically measured reservoir data.

14. The method for optimizing a hydromechanical fracturing process according to claim 1, wherein the steps (b.) of loading of a pressure-fracture aperture relationship curve and (c.) of generating a hydraulic fracture process model comprises the steps of:
Uploading the initial pressure-fracture aperture curve;
Solving the DFN flow model and calculate the pressure;
Compare the calculated pressure with real pressure data;
Updating the fracture aperture based on the pressure-fracture aperture curve and calculated pressure for each time step.

15. The method for optimizing a hydromechanical fracturing process according to claim 1, wherein the step (e.) of performing hydromechanical fracturing using the optimized process parameters comprises stimulating or enhancing production of oil or gas through preferentially induced fracture conduits within subsurface rock.
